(19) United States
(12) Patent Application Publication
(10) Pub. No.: US 2013/0331577 A1
(43) Pub. Date: Dec. 12, 2013

(54) PREPARATION OF A FAC-ISOMER FOR A TRIS HOMOLEPTIC METAL COMPLEX

(71) Applicants: Veronique Van Pee, Vilvoorde (BE); Jean-Pierre Catinat, Waudrez (BE)

(72) Inventors: Veronique Van Pee, Vilvoorde (BE); Jean-Pierre Catinat, Waudrez (BE)

(73) Assignee: Solvay SA

(21) Appl. No.: 13/988,716

(22) PCT Filed: Dec. 21, 2011
(86) PCT No.: PCT/EP2011/006465

§ 371 Date: Aug. 21, 2013

(30) Foreign Application Priority Data
Dec. 23, 2010 (EP) 10196912.9

(51) Int. Cl. C07F 15/00

(52) U.S. Cl. CPC C07F 15/0033
USPC 546/4; 548/103

(57) ABSTRACT

The present application provides a use of a mixture comprising less than 75 vol. % of an organic solvent and more than 25 vol. % of water in a preparation of a fac-isomei of a tris homoleptic metal complex, in the presence or the absence of an added salt, and with the proviso that when an added salt contains at least two oxygen atoms, it is used in an amount such that the molar ratio of the salt to the metal in a metal compound used as starting material is less than 1. The present application also provides a method of preparing a fac-isomer for a tris homoleptic metal complex using the mixture.

### TECHNICAL FIELD

The present invention generally relates to a use of a water-rich mixture for preparing metal complexes, which are typically used in organic devices such as organic light emitting diodes (OLEDs). More specifically, the present invention relates to the use of such mixture of an organic solvent and water to prepare fac-isomer of tris homoleptic metal complexes. The present invention also relates to a method of preparing fac-isomers of tris homoleptic metal complexes by using the above mixture.

### BACKGROUND ART

Cyclometallated metal complexes of transition metals (e.g., rhodium, iridium and platinum) are useful due to their photophysical and photochemical properties. Especially, these compounds are used as phosphorescent emitters in OLEDs due to their strong emission from triplet excited states.

Phosphorescent emitters used in OLEDs are mostly based on cyclometallated metal complexes, preferably iridium complexes wherein bidentate cyclometallated ligands are coordinated to metal through covalent metal-C and/or dative N-metal bonds. Octahedral tris homoleptic metal complexes exist in two isomeric forms, namely, facial (fac) and meridional (mer), following the relative position of the coordinating atoms. When three identical coordinating atoms (nitrogen or carbon) occupy one face of an octahedron, the isomer is said to be facial or fac. If these three identical coordinating atoms and the metal ion are in one plane, then the isomer is said to be meridional or mer. It is well known that the fac-isomer is typically more desirable in OLED applications since it has higher quantum yields. It is also well known that a high temperature (>200□) during synthesis can lead to rather low yields (10-30%) of fac-isomer (see Holmes et al., Inorganic Chemistry, Vol. 44, No. 22, 7992-8003 (2005), Laskar et al., Polyhedron, vol. 24, 189-200 (2005), and Ragni et al., Journal of Materials Chemistry, vol. 16, 1161-1170 (2006).

The preparation of fac-isomers or a mixture of fac- and mer-isomers by using solvents such as ethoxyethanol or diols and the like in the presence of certain additives (e.g. salts) is well known in the field of organic electronics.

Tamayo et al. (Journal American Chemical Society, 2003, 125, 7377-7387) describes different synthesis routes of tris homoleptic complexes (fac- and mer-isomer), from Ir(acac)₃, from dichloro bridged dimer or from heteroleptic complexes with acac, which are performed in glycerol.

In U.S. Patent Application 2007/0080342, tris homoleptic complexes from IrCl₃.3H₂O and ligands are prepared in the presence of a halide scavenger (e.g., Ag salts) at a temperature from 140 C to 230 C.

EP 1754267 relates to method of preparing fac-isomers by using a mixture of 80 vol. % of ethoxyethanol and 20 vol. % of water, and silver trifluoroacetate as a chloride scavenger.

U.S. Patent Application 2008/0200686 discloses a process of converting a mer-isomer of a metal complex involving at least one carbene ligand to a facial tris-cyclometallated metal complex by using organic solvents such as dioxane, water or combination thereof in the presence of a Brönsted acid.

U.S. Patent Application 2008/0312396 relates to a method of preparing facial tris-cyclometallated metal complexes in the presence of a salt which contains at least two oxygen atoms, and in a solvent mixture comprising at least one organic solvent and at least 2% by volume of water.

However, none of the above cited documents meets all the requirements necessary for a method of preparing fac-isomers of tris homoleptic metal complexes, particularly at a relatively low temperature with good selectivity and with high yields, starting from metal halide complexes or halo-bridged dimers, with cost-effectiveness. Thus, there has been a need for a new preparation method, which can better satisfy the requirements indicated above.

### SUMMARY OF INVENTION

The purpose of the present invention is to provide a new method of preparing fac-isomer for a tris homoleptic metal complex, which can overcome the above-described disadvantages and which can lead to high yields even at low temperatures optionally in the presence of a salt.

Thus, the present invention relates to the use of a water-rich mixture to prepare a fac-isomer for a tris homoleptic metal complex. It was surprisingly found that the water-rich mixture can lead to a very selective synthesis towards the facial isomer.

Also, the present method can be conducted at a relatively low temperature such as 80 C to 130 C (compared to other fac-isomer synthesis routes at temperatures >200 C). Low temperatures can generally lead to high yields due to the decrease of secondary reactions and by-products. Further, excess ligand and un-reacted starting materials can be better recovered and reused.

Also, the present invention relates to a method of preparing fac-isomers of tris homoleptic metal complexes by using a water-rich mixture.

### DESCRIPTION OF EMBODIMENTS

The present inventors tested some known procedures of synthesising fac-isomers of tris homoleptic metal complexes. With a method described in International Patent Application. WO/2006/121811 and WO/2008/156879, which describe a one-step synthesis of facial isomers from Ir(acac)₃ at a high temperature (e.g., from 240 to 260 C), the present inventors generally obtained low yields (about 9% with mc54 complex from WO/2006/121811 hereafter, see comparative example) and the procedure proved poorly reproducible.

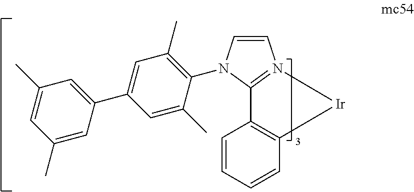

With a method described in Japanese Patent Applications. JP2008/303150 and JP2008/311607, which describe a three-step synthesis using successively chloro-bridged dimer and heteroleptic acac complex, many steps that can lead to mer-isomer were needed for synthesis and relatively low yields were obtained. In addition, there was a risk caused by silver contamination in the methods involving the use of silver salts as a chloride scavenger. When the present inventors tested a method described in U.S. Patent Application 2008/0312396, which describes a process of preparing ortho-metalated Pt-group metal compounds, fac-isomers were obtained only at low yields.

However, a new highly selective and high yield method of preparing fac-isomer has been developed, which allows the preparation of a large variety of emitters (blue, green, orange and red) at a relatively low temperature (e.g., from 80 C to 130 C) by using water-rich solvent mixtures (e.g., dioxane/water). The present inventors found that the presence of a salt is not necessary to obtain high yields of fac-isomers.

According to the present method, fac-isomers can be obtained at a rather high yield of in many cases more than 30%. Contrary to other known procedures, which are necessarily performed at high temperatures of above 200 C to form fac-isomer (mer-isomer being kinetically favoured isomer), the present method can be conducted at a relatively lower temperature (e.g., from 80 C to 130 C). This leads to the decrease of secondary reactions and by-products, and the excess ligand and un-reacted starting materials can be recovered and reused.

The present method can work well with a rather large variety of ligands.

One of the essential features of the present invention resides in the use of a water-rich mixture comprising less than 75 vol. % of an organic solvent and more than 25 vol. % of water, preferably not more than 70 vol. % of an organic solvent and at least 30 vol. % of water, and more preferably not more than 66 vol. % of an organic solvent and at least 34 vol. % of water in the preparation of fac-isomers of tris homoleptic metal complexes, in the presence or the absence of an added salt, with the proviso that when a salt is added and when this salt contains at least two oxygen atoms, such salt is used in an amount such that the molar ratio of added salt:metal in the metal compound used in the final step of the reaction is less than 1.

A water content of 40 to 60% by volume is particularly suitable.

As will be explained in more detail below, the synthesis of the fac-isomers can be carried out in a single step or a multi-step process (with certain intermediates). The ratio of organic solvent to water in multi-step processes refers to the final step only; in preceding steps where intermediates are prepared, different molar ratios may be used.

Proton ions, H₃O⁺, produced during the reaction may have an inhibitory effect. Thus, a neutralization step is preferably carried out during the reaction in order to obtain higher fac-isomer yields.

Preferably no salt is added to the reaction mixture in accordance with the present invention.

If salt is added, salts containing at least two oxygen atoms are preferably used.

Suitable salts containing at least two oxygen atoms can be either organic or inorganic. Zwitterionic compounds (the so-called internal salts) can also be used in accordance with the present invention. At least one of the oxygen atoms in the said salts with at least two oxygen atoms may be negatively charged. The oxygen atoms may be further bonded in the salts in a 1,3-, 1,4- or 1,5-arrangement, which means that the two oxygen atoms may be bound to the same or different atoms. 1,3 arrangement means that the two oxygen atoms are bound to the same atom, whereas 1,4 and 1,5 refer to structures where the oxygen atoms are not bound to the same atom, but with two respectively three atoms in between the two oxygen atoms. Examples of inorganic salts are alkali metal, alkaline earth metal, ammonium, tetraalkylammonium, tetraalkylphosphonium and/or tetraarylphosphonium carbonates, hydrogencarbonates, sulfates, hydrogensulfates, sulfites, hydrogensulfites, nitrates, nitrites, phosphates, hydrogenphosphates, dihydrogenphosphates or borates, particularly the respective alkali metal, ammonium and tetraalkylammonium salts. Examples of organic salts are alkali metal, alkaline earth metal, ammonium, tetraalkylammonium, tetraalkylphosphonium and/or tetraarylphosphonium salts of organic carboxylic acids, particularly formates, acetates, fluoroacetates, trifluoroacetates, trichloroacetates, propionates, butyrates, oxalates, benzoates, pyridinecarboxylates, salts of organic sulfonic acids, in particular MeSO₃H, EtSO₃H, PrSO₃H, F₃CSO₃H, C₄F₉SO₃H, phenyl-SO₃H, ortho-, meta- or para-tolyl-SO₃H⁻, salts of α-ketobutyric acid, and salts of pyrocatechol and salicylic acid.

In case salts with at least two oxygen atoms are added to the reaction, the molar ratio of the added salt to the metal (in the metal compounds used in the final step of the reaction) is less than 1, preferably less than 0.5, more preferably less than 0.1.

Working in the absence of added salts can simplify the preparation of fac-isomers in accordance with the present invention.

According to the present invention, the reaction is carried out in a solvent mixture comprising an organic solvent and water, preferably in solution. The term “solution” used herein relates to the solvent mixture and the added salt, if present.

As outlined before, the term “water rich” used herein denotes a mixture containing more than 25 vol. % of water. The volume percentage of organic solvent in the mixture of organic solvent and water can be less than 75%, preferably not more than 70%, and more preferably not more than 66% and the volume percent of water in the mixture of organic solvent and water can be more than 25%, preferably at least 30%, and more preferably at least 34%. A water content of 40 to 60% by volume is particularly suitable. As outlined above, the volume ratios of the solvents refer to the last step of the synthesis reaction.

The above organic solvent may be any solvent, which is miscible with water to form a single phase, i.e. a solution. Preferably, the organic solvent may be at least one selected from a group consisting of C₁˜C₂₀ alcohols, for example, methanol, ethanol, n-propanol, isopropanol, n-butanol, isobutanol or tert-butanol, oxane, for example, dioxane or trioxane, C₁˜C₂₀ alkoxyalkyl ethers, for example, bis(2-methoxyethyl) ether, C₁˜C₂₀ dialkyl ethers, for example, dimethyl ether, C₁˜C₂₀ alkoxy alcohols, for example, methoxyethanol or ethoxyethanol, diols or polyalcohols, for example, ethylene glycol, propylene glycol, triethylene glycol or glycerol, polyethylene glycol, or dimethyl sulfoxide (DMSO), N-methyl pyrrolidone (NMP) or dimethyl formamide (DMF), and combinations thereof. More preferably, the organic solvent may be at least one selected from a group consisting of dioxane, trioxane, bis(2-methoxyethyl) ether, 2-ethoxyethanol and combinations thereof. Most preferably, the organic solvent is dioxane or bis(2-methoxyethyl)ether.

In an embodiment of the present invention, the fac-isomer for a complex is prepared from a dihalo-bridged dimer, preferably a dichloro- or dibromo-bridged dimer. The non-limiting examples of dihalo-bridged dimer include those containing a bridged halogen such as a chloride bridged dimer, L₂M(μ-Cl)₂ML₂, with L being a bidentate ligand as more precisely defined hereinafter in connection with the description of the tris homoleptic complexes as such, and M being a transition metal as defined hereinafter.

The dihalo-bridged dimers may be obtained by the reaction of the metal halide complexes more precisely defined below with a ligand compound, resembling the structure ligand L. Usually, the ligand compound is the compound corresponding to L (as defined below) wherein the carbon atom providing the coordinating bond to the transition metal in the metal complex carries a hydrogen atom (cf. working examples). Thus, the ligand compound may be generally depicted as L—H (L as defined below), where the hydrogen atom is located at the coordinating carbon atom.

The volume and molar ratios in accordance with the present invention in any event only refer to the final step of manufacturing the fac isomers of the tris-homoleptic complexes, i.e. if a dihalo-bridged dimer is synthesized in a first step, which dimer is then reacted in the final step, all ratios refer to the ratios in the final step.

In another embodiment, the fac-isomer for a complex is prepared from a metal halide complex, preferably a metal chloride complex or a metal bromide complex. The synthetic procedure from a dihalo-bridged dimer or from a metal halide complex is described in U.S. Patent Application Publication No. 2008/0312396, which is incorporated herein as reference in its entirety.

Although any metal halide complex may be used as long as the purpose of the invention can be achieved, the preferred non-limiting examples of metal halide complexes include Ir halide complexes and hydrates thereof.

Preferred metal halide complexes can be characterized by the formulae MX₃*zH₂O*yHX or Yₙ(MX₆)*zH₂O*yHX wherein M is a transition metal as defined below, X is on each occurrence, identically or differently, F, Cl, Br or I, z and y are integers of from 0 to 100, Y is a mono-or divalent cation and n, in case of Y being a monovalent cation, is the charge of metal M and in case of Y being a divalent cation, is half the charge of M.

Preferred monovalent or divalent cations are alkali metal, alkaline earth metal, ammonium, tetraalkylammonium and tetraalkylphopsphonium cations.

In a preferred embodiment of the present invention, the metal complex of which the facial isomer is obtained in accordance with the present invention, is a compound represented by the formula ML₃ wherein M is a transition metal atom, preferably rhodium or iridium more preferably iridium, and L is a ligand bonded to M represented by the following formula:

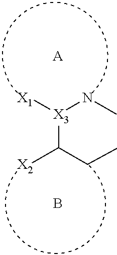

wherein:

X₁ and X₂ are same or different at each occurrence and independently selected from the group consisting of C—R¹ and N—R²; wherein R¹ or R² are independently selected from the group consisting of an unshared electron pair; hydrogen; and other substituents R as defined below,

X₃ is a carbon or a nitrogen atom,

A is selected from the group consisting of five- or six-membered aryl or heteroaryl rings and fused rings, which may be substituted with a substituent R and bound to the transition metal via a nitrogen atom,

B is selected from the group consisting of five- or six-membered aryl or heteroaryl rings and fused rings, which may be substituted with a substituent R and which ring is bound to the transition metal via a carbon atom,

Suitable substituents R, which may be the same or different on each occurrence are halogen, NO₂, CN, NH₂, NHR³, N(R³)₂, B(OH)₂, B(OR³)₂, CHO, COOH, CONH₂, CON(R³)₂, CONHR³, SO₃H, C(═O)R³, P(═O)(R³)₂, S(═O)R³, S(═O)₂R³, P(R³)₃⁺, N(R³)₃⁺, OH, SH, a straight chain alkyl or alkoxy group having 1 to 20 carbon atoms or a branched or cyclic alkyl or alkoxy group with 3 to 20 carbon atoms, a substituted or unsubstituted aromatic or heteroaromatic ring system having 5 to 30 ring atoms or a substituted or unsubstituted aryloxy, heteroaryloxy or heteroarylamino group having 5 to 30 ring atoms.

Two or more substituents R, either on the same or on different rings may define a further mono- or polycyclic, aliphatic or aromatic ring system with one another or with a substituent R¹, R² or R³.

R³, which may be the same or different on each occurrence, may be a straight chain alkyl or alkoxy group having 1 to 20 carbon atoms or a branched or cyclic alkyl or alkoxy group with 3 to 20 carbon atoms, a substituted or unsubstituted aromatic or heteroaromatic ring system having 5 to 30 ring atoms or a substituted or unsubstituted aryloxy, heteroaryloxy or heteroarylamino group having 5 to 30 ring atoms.

Two or more substituents R³, either on the same or on different rings may define a further mono- or polycyclic, aliphatic or aromatic ring system with one another or with a substituent R¹, R² or R.

In one embodiment of the present invention, the metal complex contains at least one cyclometallated ligand. In a preferred embodiment, the cyclometallated ligand is selected from the group consisting of phenylpyridine derivatives, phenylimidazole derivatives, phenylisoquinoline derivatives, phenylquinoline derivatives, phenylpyrazole derivatives, phenyltriazole derivatives and phenyltetrazole derivatives.

According to a particularly preferred embodiment, the metal complex ML₃ is an iridium complex, in particular an iridium complex selected from the following compounds:

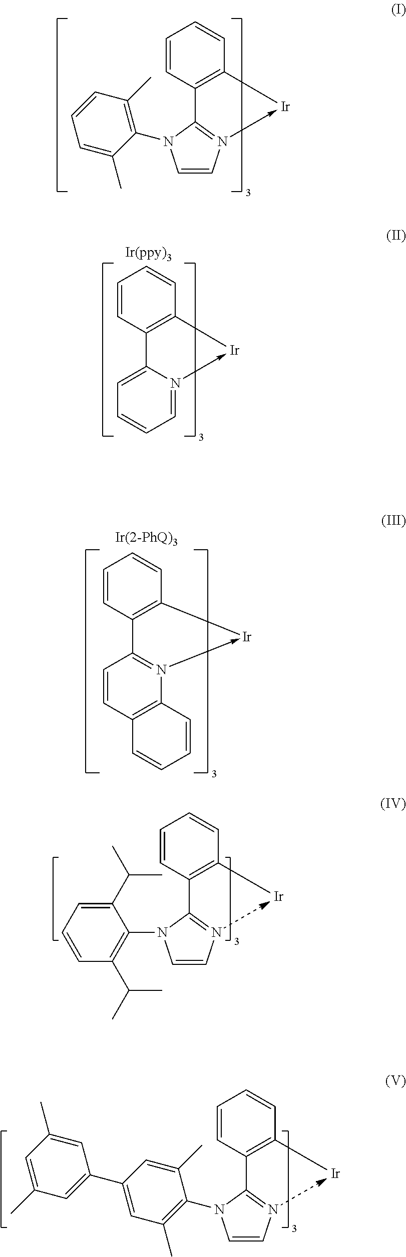

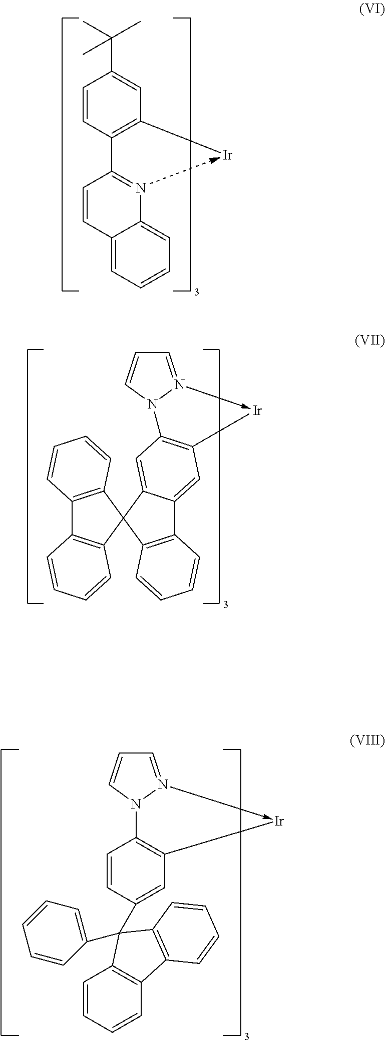

The present invention further relates to a process for the manufacture of fac-isomers of tris homoleptic metal complexes ML₃ by reacting dihalo bridged dimers of formula L₂M(μ-Hal)₂ML₂ or of metal halide complexes of formula MX₃*zH₂O*yHX or Yₙ(MX₆)*zH₂O*y HX, wherein

X is on each occurrence, identically or differently, F, Cl, Br or I, z and y are integers of from 0 to 100, Y is a mono-or divalent cation and n, in case of Y being a monovalent cation, is the charge of metal M and in case of Y being a divalent cation, is half the charge of M
M is a transition metal,
L is a ligand of formula

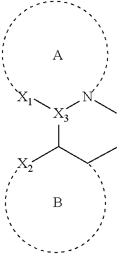

wherein
X₁ and X₂ are same or different at each occurrence and independently selected from the group consisting of C—R¹ and N—R²;
   X₃ is a carbon atom or a nitrogen atom
R¹ and R² are selected from the group consisting of an unshared electron pair; hydrogen; and other substituents R,
A is selected from the group consisting of five- or six-membered aryl or heteroaryl rings and fused rings, which may be substituted with a substituent R and which ring is bound to the transition metal via a nitrogen atom,
B is selected from the group consisting of five- or six-membered aryl or heteroaryl rings and fused rings, which may be substituted with a substituent R and which ring is bound to the transition metal via a carbon atom,
with a ligand compound L—H in which the hydrogen is bound to the carbon atom bound to the transition metal in the tris-homoleptic complex, in a solvent mixture comprising less than 75 vol % of an organic solvent and more than 25 vol % of water in the presence or absence of an added salt.

Accordingly, another aspect of the present invention is directed to a method of preparing a fac-isomer for a tris homoleptic metal complex by using a water/organic solvent mixture comprising less than 75 vol. % of an organic solvent and more than 25 vol. % of water, preferably not more than 70 vol. % of an organic solvent and at least 30 vol. % of water, and more preferably not more than 66 vol. % of an organic solvent and at least 34 vol. % of water. A water content of 40 to 60% by volume is particularly suitable.

The reaction can be carried out in the presence of a salt, and when this salt contains at least two oxygen atoms, the molar ratio of the added salt to the metal is less than 1, preferably less than 0.5, and most preferably less than 0.1. Metal in this regard refers to the metal in the halo-bridged dimers or the metal halide complexes used in the final step of the reaction.

In specific embodiments of the present invention, at least one ligand compound (as defined above) is added to the mixture to prepare a fac-isomer of the tris homoleptic metal complex. A stoichiometric excess amount of the ligand compound, relative to the amount of metal in the metal containing starting material in the final step of the reaction (usually the dihalo-bridged dimer or a metal halide complex as defined above) is generally preferably used to improve the fac-isomer yield in the method according to the present invention. In a more specific embodiment, the ligand compound is used in an amount of 10 to 3000 mol percent excess, preferably 50 to 1000 mol percent excess, most preferably 100 to 750 mol percent excess. The molar excess for the purposes of this invention refers to the respective excess in the final step of the reaction, i.e. the step where the complex ML₃ is formed. In multi-step processes the molar ratios of ligand compounds to metal halide complex in the initial steps may be different and outside the preferred ranges given above.

The fac-isomer for a tris homoleptic metal complex can be prepared at a temperature of from 50 to 260 C, preferably of from 80 to 130 C. The temperature may depend on the solvent mixture and/or ligand used. For example, in preparation of the metal complex of Formula (I) where 2-phenyl-1-(2,6-dimethyl-phenyl)imidazole is used, the reaction proceeds well at 80° C. in a mixture of dioxane and water. However, the fac-isomer yields of the metal complexes of Formulae (II) and (III) having 2-phenylpyridine and 2-phenylquinoline ligands, respectively, are significantly lower under the identical conditions. Instead, in preparation of the metal complexes of Formulae (II) and (III), a mixture of diglyme and water and the temperature condition of 130° C. are preferably used. These reaction conditions as above, which are significantly milder than the reaction conditions of the prior art, offer the advantage that the reaction can also be carried out with thermally and/or chemically sensitive ligands, and that ligand-exchange reactions remain limited at these temperatures.

In some specific embodiments, the isomer is prepared at a pressure of from 1×10³ to 1×10⁸ Pa, preferably 1×10⁴ to 1×10⁷ Pa, and most preferably 1×10⁵ to 1×10⁶ Pa.

The metal complex synthesized by the present method can be typically used as phosphorescent emitter in organic devices, e.g., OLEDs. As for the structure of OLEDs, a typical OLED is composed of a layer of organic emissive materials, which can comprise either fluorescent or phosphorescent materials and optionally other materials such as charge transport materials, situated between two electrodes. The anode is generally a transparent material such as indium tin oxide (ITO), while the cathode is generally a metal such as Al or Ca. The OLEDs can optionally comprise other layers such as hole injection layer (HIL), hole transporting layer (HTL), electron blocking layer (EBL), hole blocking layer (HBL), electron transporting layer (ETL) and electron injection layer (EIL).

Phosphorescent OLEDs use the principle of electrophosphorescence to convert electrical energy into light in a highly efficient manner, with internal quantum efficiencies of such devices approaching 100%. Iridium complexes such as compounds (I), (II) or (III) are currently widely used. The heavy metal atom at the center of these complexes exhibits strong spin-orbit coupling, facilitating intersystem crossing between singlet and triplet states. By using these phosphorescent materials, both singlet and triplet excitons can decay radiatively, hence improving the internal quantum efficiency of the device compared to a standard fluorescent emitter where only the singlet states will contribute to emission of light. Applications of OLEDs in solid state lighting require the achievement of high brightness with good CIE coordinates (for white emission).

The above OLEDs comprising phosphorescent emitters obtained in accordance with the present invention can be fabricated by any method conventionally used in the field of organic devices, for example, vacuum evaporation, thermal deposition, printing or coating.

Now, some embodiments will be provided to facilitate the understanding of the present invention. However, it is important to note that the above-described specific embodiments are only described herein for illustrative purposes. The specific procedures, materials or conditions should not be construed in any manner as limiting the scope of the present invention. Further, any other methods, materials or conditions, which are obvious to a person of ordinary skill in the art, are also readily covered by the present invention.

### EXAMPLES

All the reactions were performed in the dark and under inert atmosphere

### Example 1

### Preparation of a Fac-Isomer of the Metal Complex of Formula (I)

1^{st} Step: Preparation of a Chloro-Bridged Dimer, L₂Ir(μ-Cl)₂IrL₂, from IrCl₃.xH₂O

In a 250 ml round bottom flask flushed with argon were introduced 3 g of IrCl₃.xH₂O (8.2 mmol) and 6.1 g of 1-(2,6-dimethylphenyl)-2-phenyl-1H-imidazole ligand (24.6 mmol) followed by addition of 168 ml of a 3:1 (v/v) mixture of 2-ethoxyethanol and water. The resulting mixture was outgassed and maintained under stirring at reflux for 21 h. After cooling, the precipitate was filtered off with suction, washed with methanol and diethylether and dried under vacuum. The reaction yield was 90%.

### 2^{nd} Step: Preparation of a Fac-Isomer of the Metal Complex of Formula (I) in a 1/1 v/v Mixture of Dioxane and Water

To a 50 ml vial flushed with argon were introduced 0.265 g of the chloro-bridged dimer synthesized hereabove, 0.358 g of 1-(2,6-dimethylphenyl)-2-phenyl-1H-imidazole ligand and 34 ml of a 1:1 v/v mixture of dioxane and water. After sealing, the vial was heated under stirring at 80° C. for 144 hours. After cooling, the precipitate was filtered off with suction and washed with water and hexane. NMR analysis indicated that the recovered solid contained 87 wt % of the fac-isomer and 9.3 wt % of un-reacted dimer, which corresponds to a fac-isomer yield equal to 75%. No mer-isomer was detected. Pure fac-isomer could be isolated from un-reacted dimer using classical flash chromatography.

### Example 2

### Preparation of a Fac-Isomer of the Metal Complex of Formula (I) in a Different Solvent Mixture

A fac-isomer of the metal complex of formula (I) was obtained in an identical manner to Example 1 except that in the 2^{nd} step a 1:1 v/v mixture of diglyme and water was used as solvent instead of the 1:1 v/v mixture of dioxane and water, and the vial was heated at 130° C. for 48 hours. The fac-isomer yield estimated as in example 1 was 62%; no mer-isomer was detected.

### Example 3

### Preparation of a Fac-Isomer of the Metal Complex of Formula (I) in a Different Solvent Mixture

A fac-isomer of the metal complex of formula (I) was obtained in an identical manner to Example 1 except that in the 2^{nd} step a 1:1 v/v mixture of 2-ethoxyethanol and water was used as solvent instead of the 1:1 v/v mixture of dioxane and water. The fac-isomer yield was 49%, no mer-isomer was detected.

### Example 4

### Preparation of a Fac-Isomer of the Metal Complex of Formula (I): Effect of a Neutralization Step

A fac-isomer of the metal complex of formula (I) was obtained in an identical manner to Example 1 except that in the 2^{nd} step, the reaction mixture was filtered after being heated under stirring at 80° C. for 72 hours and the filtrate was neutralized with an 0.1M solution of NaOH in dioxane/water 1:1 v/v until reaching the same pH value as that initially measured on the mixture consisting of the ligand and the two solvents. Then the recovered solid and the neutralized filtrate were gathered back and the resulting mixture was further heated under stirring at 80° C. for 72 hours. The fac-isomer yield increased when compared to example 1, reaching 87%. No mer-isomer was detected.

### Example 5

### Preparation of a Fac-Isomer of the Metal Complex of Formula (I) in a 70:30 v/v Mixture of Dioxane and Water

The procedure was identical to Example 1 except that in the 2^{nd} step a 70:30 v/v mixture of dioxane and water was used as solvent instead of the 1:1 v/v mixture of dioxane and water. The fac-isomer yield estimated as in example 1 was 14%; no mer-isomer was detected.

### Example 6

### Comparative Example: Preparation of a Fac-Isomer of the Metal Complex of Formula (I) in a 3:1 v/v Mixture of Dioxane and Water

The procedure was identical to Example 1 except that in the 2^{nd} step a 3:1 v/v mixture of dioxane and water was used as solvent instead of the 1:1 v/v mixture of dioxane and water. No fac-isomer was detected by NMR analysis of the precipitate recovered at the end of the procedure.

### Example 7

### Comparative Example: Preparation of a Fac-Isomer of the Metal Complex of Formula (I) in Pure Dioxane

The procedure was identical to Example 1 except that in the 2^{nd} step pure dioxane was used as solvent instead of the 1:1 v/v mixture of dioxane and water. NMR analysis of the precipitate recovered at the end of the procedure indicated no traces of fac-isomer, showing only un-reacted dimer.

### Example 8

### Preparation of a Fac-Isomer of the Metal Complex of Formula (I) in 1/1 v/v Dioxane/Water Mixture in the Presence of Dimethylglycine as Salt in an Amount Such that the Molar Ratio of the Added Salt to the Iridium Metal is Equal to 0.9 Mol/Mol

The procedure was identical to Example 1 except that in the 2^{nd} step dimethylglycine was added as an internal salt in a amount such that the molar ratio of the dimethylglycine to the chloro-bridged dimer was equal to 1.8 mol/mol, which corresponds to a dimethylglycine to iridium metal molar ratio equal to 0.9 mol/mol. The fac-isomer yield estimated as in example 1 was 76%; no mer-isomer was detected.

### Example 9

### Comparative Example: Preparation of a Fac-Isomer of the Metal Complex of Formula (I) in 1/1 v/v Dioxane/Water Mixture in the Presence of Dimethylglycine as Salt in an Amount Such That the Molar Ratio of the Added Salt to the Iridium Metal is Equal to 30 Mol/Mol

The procedure was identical to Example 8 except that in the 2^{nd} step dimethylglycine was added as a internal salt in a amount such that the molar ratio of the dimethylglycine to the chloro-bridged dimer was equal to 60 mol/mol, which corresponds to a dimethylglycine to iridium metal molar ratio equal to 30 mol/mol. The fac-isomer yield estimated as in example 1 was 45%, a value significantly lower than in example 8. No mer-isomer was detected.

| | | T° | | Fac-isomer |
|---|---|---|---|---|
| | Solvent | (° C.) | Time (h) | yield (%) |
| Example 1 | Dioxane/water 1/1 v/v | 80 | 144 | 75 |
| Example 2 | Diglyme/water 1/1 v/v | 130 | 48 | 62 |
| Example 3 | 2-ethoxyethanol/water 1/1 v/v | 80 | 144 | 49 |
| Example 4 | Dioxane/water 1/1 v/v + | 80 | 2 × 72 | 87 |
| | filtrate neutralization after 72 h | | | |
| Example 5 | Dioxane/water 70/30 v/v | 80 | 144 | 14 |
| Example 6 | Dioxane/water 3/1 v/v | 80 | 144 | No fac |
| Compar. | | | | detected |
| Example 7 | Pure dioxane | 80 | 144 | No fac |
| Compar. | | | | detected |
| Example 8 | Dioxane/water 1/1 v/v | 80 | 144 | 76 |
| | with salt/iridium metal molar | | | |
| | ratio equal to 0.9 mol/mol | | | |
| Example 9 | Dioxane/water 1/1 v/v | 80 | 144 | 45 |
| Compar. | with salt/iridium metal molar | | | |
| | ratio equal to 30 mol/mol | | | |

### Example 10

### Preparation of a Fac-Isomer of the Metal Complex of Formula (I) in a 1/1 v/v Mixture of Dioxane and Water Starting from IrCl₃.xH₂O

To a 100 ml vial flushed with argon were introduced 0.94 g of 1-(2,6-dimethylphenyl)-2-phenyl-1H-imidazole ligand (3.8 mmol), 68 ml of a 1:1 v/v mixture of dioxane and water and 0.233 g of IrCl₃.xH₂O (0.63 mmol). After sealing, the vial was heated under stirring at 80° C. for 22 hours. After cooling, the precipitate was filtered off with suction and the filtrate was neutralized with an 0.1M solution of NaOH in dioxane/water 1:1 v/v until reaching the same pH value as that initially measured on the mixture consisting of the ligand and the two solvents. After then the mixture of the precipitate and the neutralized filtrate was further heated under stirring at 80° C. for 144 hours. After cooling, the precipitate was filtered off with suction and washed with hexane. The fac-isomer yield estimated as in example 1 was 47%; no mer-isomer was detected.

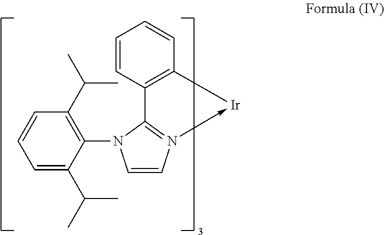

### Example 11

### Preparation of a Fac-Isomer of the Metal Complex of Formula (IV)

1^{st} Step: Preparation of a Chloro-Bridged Dimer from IrCl₃.xH₂O

In a 500 ml round bottom flask flushed with argon were introduced IrCl₃.xH₂O (6.48 g, 18.3 mmol) and 1-(2,6-diisopropylphenyl)-2-phenyl-1H-imidazole ligand (16.74 g, 55 mmol) followed by addition of 356 ml of a 3:1 (v/v) mixture of 2-ethoxy-ethanol and water. The resulting mixture was outgassed and heated under stirring at reflux for 21 h. After cooling, the precipitate was filtered off with suction, washed with methanol and dried under vacuum. The reaction yield was 84%.

### 2^{nd} Step: Preparation of a Fac-Isomer of the Metal Complex of Formula (IV)

A fac-isomer of the metal complex of formula (IV) was obtained in an identical manner to Example 1 except that 1-(2,6-diisopropylphenyl)-2-phenyl-1H-imidazole was used as ligand instead of 1-(2,6-dimethylphenyl)-2-phenyl-1H-imidazole. The fac-isomer yield estimated, as in example 1, from NMR analysis of the recovered precipitate is equal to 85%; no mer-isomer was detected.

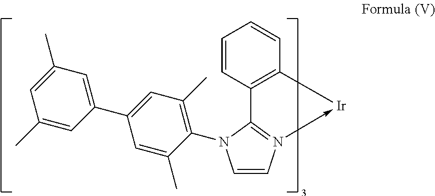

### Example 12

### Preparation of a Fac-Isomer of the Metal Complex of Formula (V)

1^{st} Step: Preparation of a Chloro-Bridged Dimer from IrCl₃.xH₂O

The chloro-bridged dimer was obtained in an identical manner to example 1 except that 2-phenyl-1-(3,3′,5,5′-tetramethylbiphenyl-4-yl)-1H-imidazole was used as ligand instead of 1-(2,6-dimethylphenyl)-2-phenyl-1H-imidazole. The reaction yield was 73%.

### 2^{nd} Step: Preparation of a Fac-Isomer of the Metal Complex of Formula (V)

To a 100 ml vial flushed with argon were introduced 84 ml of a 1:1 v/v mixture of diglyme and water, 1.16 g of 2-phenyl-1-(3,3′,5,5′-tetramethylbiphenyl-4-yl)-1H-imidazole ligand and 0.91 g of the chloro-bridged dimer synthesized hereabove. After sealing the vial was heated under stirring at 130° C. for 72 hours. After cooling, the precipitate was filtered off and the filtrate was neutralized with an 0.1M solution of NaOH in diglyme/water 1:1 v/v until reaching the same pH value as that initially measured on the mixture consisting of the ligand and the two solvents. After then the precipitate and the neutralized filtrate were gathered back and the resulting mixture was further heated under stirring at 130° C. for 72 hours. After cooling, the precipitate was filtered off with suction and washed with water and hexane. The resulting solid was purified by silica gel column chromatography using CH₂Cl₂/hexane 8:2 (v/v) as the eluent to give 0.44 g of the fac-isomer (yield: 43%).

### Example 13

### Comparative Example. Preparation of a Fac-Isomer of the Metal Complex of Formula (V) Using the Method Starting from Ir(acac)₃ Described in WO/2006121811 and WO2008/156879.

The 2-phenyl-1-(3,3′,5,5′-tetramethylbiphenyl-4-yl)-1H-imidazole ligand (0.76 g, 2.18 mmol) and Ir(acac)₃ (0.201 g, 0.41 mmol) were introduced in a vial which was subsequently evacuated and backfilled with argon. The vial was then heated under stirring up to 240° C. for 48 h in a sand bath. After cooling, the resulting solid was dissolved in 6 ml of CH₂Cl₂ and purified by silica gel column chromatography using CH₂Cl₂/hexane 8:2 (v/v) as the eluent to yield 0.050 g of the fac-isomer (yield: 9.8%).

### Example 14

### Preparation of a Fac-Isomer of the Metal Complex of Formula (II)

A fac-isomer of the metal complex of formula (II) was obtained in an identical manner to Example 1 except that 2-phenylpyridine was used as ligand instead of 1-(2,6-dimethylphenyl)-2-phenyl-1H-imidazole. The fac-isomer yield in the 2^{nd} step estimated, as in example 1 from NMR analysis of the recovered precipitate is equal to 16%; no mer-isomer was detected.

### Example 15

### Preparation of a Fac-Isomer of the Metal Complex of Formula (II) in a Different Solvent Mixture and at Higher T°

A fac-isomer of the metal complex of formula (II) was obtained in an identical manner to Example 14 except that in the 2^{nd} a 1:1 v/v mixture of diglyme and water was used as solvent instead of the 1:1 v/v mixture of dioxane and water, and the vial was heated at 130° C. The fac-isomer yield was 95%; no mer-isomer was detected

### Example 16

### Preparation of a Fac-Isomer of the Metal Complex of Formula (III)

A run to synthesize the fac-isomer of the metal complex of formula (III) was performed in an identical manner to Example 1 except that 2-phenylquinoline was used as ligand instead of 1-(2,6-dimethylphenyl)-2-phenyl-1H-imidazole. NMR analysis of the precipitate recovered at the end of the 2^{nd} step indicated no traces of fac-isomer showing only un-reacted dimer.

### Example 17

### Preparation of a Fac-Isomer of the Metal Complex of Formula (III) in a Different Solvent Mixture and at Higher T°

A fac-isomer of the metal complex of formula (III) was obtained in an identical manner to Example 16 except that in the 2^{nd} step a 1:1 v/v mixture of diglyme and water was used as solvent instead of the 1:1 v/v mixture of dioxane and water, and the vial was heated at 130° C. The fac-isomer yield was 67%; no mer-isomer was detected.

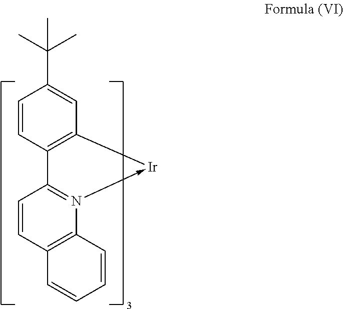

### Example 18

### Preparation of a Fac-Isomer of the Metal Complex of Formula (VI)

1^{st} Step: Preparation of a Chloro-Bridged Dimer from IrCl₃.xH₂O

In a 500 ml round bottom flask flushed with argon were introduced IrCl₃.xH₂O (2.7 g, 7.2 mmol) and 2-(4-tert-butylphenyl)quinoline ligand (4.9 g, 19 mmol) followed by addition of 270 ml of a 3:1 (v/v) mixture of 2-ethoxy-ethanol and water. The resulting mixture was outgassed and heated under stirring at reflux for 24 h. After cooling, the precipitate was filtered off with suction, washed with water and hexane and dried under vacuum. The reaction yield was 68%.

### 2^{nd} Step: Preparation of a Fac-Isomer of the Metal Complex of Formula (VI)

To a 100 ml vial flushed with argon were introduced 0.93 g of 2-(4-tert-butylphenyl)quinoline ligand, 86 ml of a 1:1 v/v mixture of diglyme and water and 0.70 g of the chloro-bridged dimer synthesized hereabove. After sealing the vial was heated under stirring at 130° C. for 90 hours. After cooling, the precipitate was filtered off and the filtrate was neutralized with an 0.1M solution of NaOH in diglyme/water 1:1 v/v until reaching the same pH value as that initially measured on the mixture consisting of the ligand and the two solvents. After then the precipitate and the neutralized filtrate were gathered back and the resulting mixture was further heated under stirring at 130° C. for 115 hours. After cooling, the precipitate was filtered off with suction and washed with water and hexane. The fac-isomer yield estimated as in example 1 was 43%; no mer-isomer was detected.

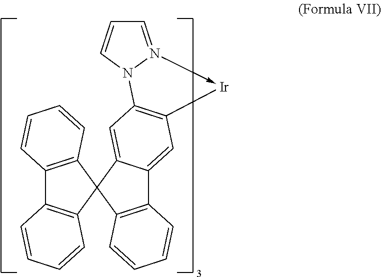

### Example 19

### Preparation of a Fac-Isomer of the Complex of Formula (VII)

1^{st} Step: Preparation of a Chloro-Bridged Dimer from IrCl₃.xH₂O

In a 100 ml round bottom flask flushed with argon was introduced IrCl₃.xH₂O (0.35 g, 0.96 mmol) and 1-(9,9′-spirobifluoren2-yl)-pyrazole ligand (1.10 g, 2.88 mmol) followed by addition of 20 ml of a 3:1 (v/v) mixture of 2-ethoxyethanol and water. The resulting mixture was outgassed and heated under stirring at reflux for 21 h. The precipitate was collected by filtration and washed twice with MeOH (10 ml) and ether (20 ml) to yield the product as a pale yellow powder (74% yield).

### 2^{nd} Step: Preparation of a Fac-Isomer of the Metal Complex of Formula (VII)

In a 50 ml vial flushed with argon were introduced the chloro-bridged dimer synthesized hereabove (0.218 g, 0.11 mmol) and the 1-(9,9′-spirobifluoren-2-yl)-pyrazole ligand (0.337 g, 0.88 mmol) followed by addition of 22 ml of a 1:1 (v/v) mixture of diglyme and water. The solution was outgassed and the mixture heated under stirring at 130° C. for 144 h. The resulting precipitate was filtered and washed with 3×25 ml of hexane. Yield estimated from NMR spectrum was equal to 14%.

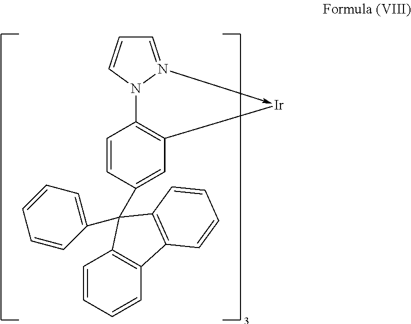

### Example 20

### Preparation of a Fac-Isomer of the Complex of Formula (VIII)

The complex was synthesized as described in example 19. The chloro-bridged dimer was obtained with a yield equal to 97% from (1-(4-(9-phenyl-9H-fluoren-9-yl)phenyl)-pyrazole ligand (3.195 g, 8.31 mmol) and IrCl₃.xH₂O (1.019 g, 2.77 mmol). The fac-complex was obtained from the dimer (0.177 g, 0.089 mmol) and (1-(4-(9-phenyl-9H-fluoren-9-yl)phenyl)-pyrazole ligand (0.274 g, 0.71 mmol) with 9% yield after purification by silica gel column chromatography using CH₂Cl₂/hexane 8:2 (v/v) as the eluent.

### INDUSTRIAL APPLICABILITY

The present invention can be used to manufacture phosphorescent OLEDs having improved performances such as higher efficiency and longer life time. The present invention also provides a cost-effective and high-yield procedure of preparing a fac-isomer for a tris homoleptic or heteroleptic metal complex.

1. A use of a mixture comprising less than 75 vol. % of an organic solvent and more than 25 vol. % of water in a preparation of afac-isomer of a tris homoleptic metal complex, in the presence or the absence of an added salt, with the proviso that when an added salt contains at least two oxygen atoms, it is used in an amount such that the molar ratio of the salt to the metal in a metal compound used as starting material is less than 1.

2. The use of in accordance with claim 1, wherein the preparation of the fac-isomer of a tris homoleptic metal complex is conducted in the absence of any added salt.

3. The use in accordance with claim 1, wherein the mixture comprises not more than 70 vol. % of an organic solvent and at least 30 vol. % of water, preferably not more than 66 vol. % of an organic solvent and at least 34 vol. % of water, more preferably not more than 60 vol % of an organic solvent and at least 40 vol % of water.

4. The use in accordance with claim 1, wherein the fac-isomer of a tris-homoleptic metal complex is prepared from a dihalo-bridged dimer, preferably a dichloro- or dibromo-bridged dimer.

5. The use in accordance with claim 1, wherein the fac-isomer of a tris homoleptic metal complex is prepared from a metal halide complex, preferably a metal chloride complex or a metal bromide complex.

6. The use in accordance with claim 5, wherein the metal halide complex is selected from the group consisting of Ir halide complex and hydrates thereof.

7. The use in accordance with claim 1, wherein the metal complex is an Ir complex.

8. The use in accordance with claim 1, wherein the metal complex is a compound represented by the formula: ML₃
wherein M is a transition metal atom, preferably rhodium or iridium, more preferably iridium, and
L is a ligand bonded to M represented by the following formula: 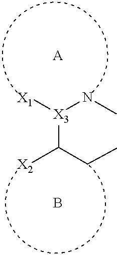
wherein:
X₁ and X₂ are same or different at each occurrence and independently selected from the group consisting of C—R¹ and N—R²;
X₃ is a carbon atom or a nitrogen atom,
R¹ and R² are independently selected from the group consisting of an unshared electron pair; hydrogen; and other substituents R,
A is selected from the group consisting of five- or six-membered aryl or heteroaryl rings and fused rings, which may be substituted with a substituent R and which ring is bound to the transition metal via a nitrogen atom, and
B is selected from the group consisting of five- or six-membered aryl or heteroaryl rings and fused rings, which may be substituted with a substituent R and which ring is bound to the transition metal via a carbon atom.

9. The use in accordance with claim 8, wherein R may be the same or different on each occurrence and is selected from the group consisting of halogen, NO₂, CN, NH₂, NHR³, N(R³)₂, B(OH)₂, B(OR³)₂, CHO, COOH, CONH₂, CON(R³)₂, CONHR³, SO₃H, C(═O)R³, P(═O)(R³)₂, S(═O)R³, S(═O)₂R³, P(R³)₃⁺, N(R³)₃⁺, OH, SH, a straight chain alkyl or alkoxy group having 1 to 20 carbon atoms or a branched or cyclic alkyl or alkoxy group with 3 to 20 carbon atoms, a substituted or unsubstituted aromatic or heteroaromatic ring system having 5 to 30 ring atoms or a substituted or unsubstituted aryloxy, heteroaryloxy or heteroarylamino group having 5 to 30 ring atoms, wherein two or more substituents R, either on the same or on different rings may define a further mono- or polycyclic, aliphatic or aromatic ring system with one another or with a substituent R¹, R² or R³.
R³, which may be the same or different on each occurrence, may be a straight chain alkyl or alkoxy group having 1 to 20 carbon atoms or a branched or cyclic alkyl or alkoxy group with 3 to 20 carbon atoms, a substituted or unsubstituted aromatic or heteroaromatic ring system having 5 to 30 ring atoms or a substituted or unsubstituted aryloxy, heteroaryloxy or heteroarylamino group having 5 to 30 ring atoms, and two or more substituents R³, either on the same or on different rings may define a further mono- or polycyclic, aliphatic or aromatic ring system with one another or with a substituent R¹, R² or R.

10. The use of the mixture of claim 1, wherein the metal complex contains at least one cyclometallated ligand, preferably selected from the group consisting of phenylpyridine derivatives, phenylimidazole derivatives, phenylquinoline derivatives, phenylisoquinoline derivatives phenylpyrazole derivatives, phenyltriazole derivatives and phenyltetrazole derivatives.

11. The use in accordance with claim 10, wherein the metal complex is an iridium complex and the iridium complex is at least one selected from the following compounds:

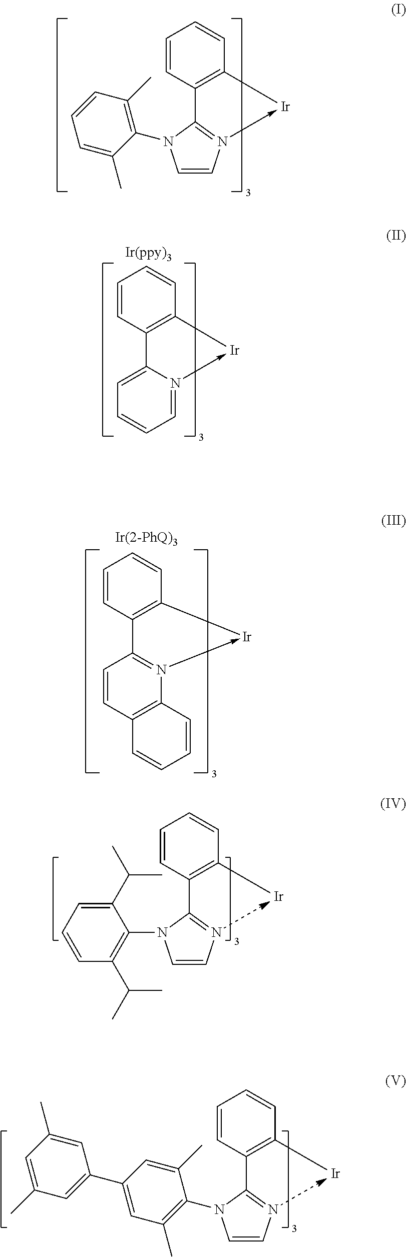

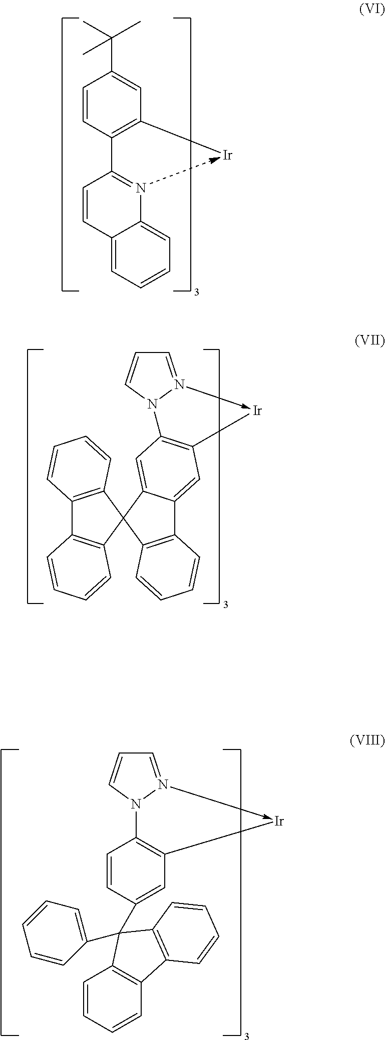

12. The use in accordance with claim 1, wherein the organic solvent is at least one selected from the group consisting of C₁˜C₂₀ alcohols, oxanes, C₁˜C₂₀ alkoxyalkyl ethers, C₁˜C₂₀ dialkyl ethers, C₁˜C₂₀ alkoxy alcohols, diols or polyalcohols, polyethylene glycols, DMSO, NMP, DMF and combinations thereof, preferably at least one selected from the group consisting of dioxane, trioxane, bis(2-methoxyethyl)ether, 2-ethoxyethanol and combinations thereof.

13. The use in accordance with claim 12, wherein the organic solvent is dioxane or bis(2-methoxyethyl)ether.

14. The use in accordance with claim 1, wherein the fac-isomer for a tris homoleptic metal complex is prepared at a temperature from 50 C to 260 C, preferably from 80 C to 130 C.

15. A process for the manufacture of fac-isomers of tris homoleptic metal complexes ML₃ by reacting dihalo bridged dimers of formula L₂M(μ-Hal)₂ML₂ or of metal halide complexes of formula MX₃*zH₂O*yHX or Yₙ(MX₆)*zH₂O*yHX, wherein X is on each occurrence, identically or differently, F, Cl, Br or I, z and y are integers of from 0 to 100, Y is a mono-or divalent cation and n, in case of Y being a monovalent cation, is the charge of metal M and in case of Y being a divalent cation, is half the charge of M
M is a transition metal,
L is a ligand of formula
wherein
X₁ and X₂ are same or different at each occurrence and independently selected from the group 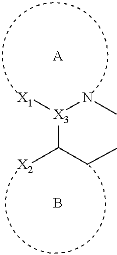
consisting of C—R¹ and N—R²;
X₃ is a carbon atom or a nitrogen atom,
R¹ and R² are independently selected from the group consisting of an unshared electron pair; hydrogen; and other substituents R,
A is selected from the group consisting of five- or six-membered aryl or heteroaryl rings and fused rings, which may be substituted with a substituent R and which ring is bound to the transition metal via a nitrogen atom,
B is selected from the group consisting of five- or six-membered aryl or heteroaryl rings and fused rings, which may be substituted with a substituent R and which ring is bound to the transition metal via a carbon atom,
with a ligand compound L—H in which the hydrogen is bound to the carbon atom bound to the transition metal in the tris-homoleptic complex, in a solvent mixture comprising less than 75 vol % of an organic solvent and more than 25 vol % of water in the presence or absence of an added salt.
